(19) United States
(12) Patent Application Publication
(10) Pub. No.: US 2021/0150898 A1
(43) Pub. Date: May 20, 2021

(54) METHOD FOR CONTROLLING TRAFFIC SIGNALS AND APPARATUS, COMPUTER DEVICE AND STORAGE MEDIUM

(71) Applicant: BEIJING BAIDU NETCOM SCIENCE AND TECHNOLOGY CO., LTD., Beijing (CN)

(72) Inventor: Qiqi XU, Beijing (CN)

(21) Appl. No.: 17/034,111

(22) Filed: Sep. 28, 2020

(30) Foreign Application Priority Data
Nov. 14, 2019 (CN) 201911111065.2

(51) Int. Cl. G08G 1/08; G08G 1/082; G08G 1/01

(52) U.S. Cl. CPC G08G 1/08; G08G 1/0145; G08G 1/0129; G08G 1/082

(57) ABSTRACT

The present disclosure discloses a method for controlling traffic signals and apparatus, and a storage medium. The specific implementation solution is: obtaining degrees of congestion detected at an intersection at respective time periods; clustering the time periods based on the degrees of congestion to obtain a plurality of clusters; determining target clusters from the plurality of clusters based on the degrees of congestion, wherein the degrees of congestion at the time periods included in the target clusters are greater than those at the time periods included in the rest clusters; determining a peak period based on the time periods included in the target clusters; and controlling the traffic signals during the peak period by using a signal control configuration corresponding to the peak period.

### CROSS REFERENCE TO RELATED APPLICATION

This application claims priority to Chinese Patent Application No. 201911111065.2, filed with the State Intellectual Property Office of P. R. China on Nov. 14, 2019, the entire contents of which are incorporated herein by reference.

### TECHNICAL FIELD

The present disclosure relates to the field of data processing and intelligent transportation technology, and more particularly, to a method for controlling traffic signals and apparatus, a computer device and a storage medium.

### BACKGROUND

At present, when determining a signal control configuration for a traffic light at an intersection, it is necessary to refer to traffic of vehicles at the intersection to design different signal control configurations. Normally, different signal control configurations are adopted for the peak period, the off-peak period, and the evening period, so that a signal control configuration matching characteristics of a corresponding time period may be selected. Therefore, how to accurately recognize the peak period of traffic is of great significance to the matching of a signal control configuration and a time period.

### SUMMARY

Embodiments of a first aspect of the present disclosure provide a method for controlling traffic signals, including: obtaining degrees of congestion detected at an intersection at respective time periods; clustering the time periods based on the degrees of congestion to obtain a plurality of clusters; determining target clusters from the plurality of clusters based on the degrees of congestion, in which degrees of congestion at time periods included in the target clusters are greater than degrees of congestion at time periods included in the rest clusters; determining a peak period based on the time periods included in the target clusters; and controlling the traffic signals during the peak period by using a signal control configuration corresponding to the peak period.

Embodiments of a second aspect of the present disclosure provide an apparatus for controlling traffic signals, including: an obtaining module, configured to obtain degrees of congestion detected at an intersection at respective time periods; a clustering module, configured to cluster the time periods based on the degrees of congestion to obtain a plurality of clusters; a selection module, configured to determine target clusters from the plurality of clusters based on the degrees of congestion, in which degrees of congestion at time periods included in the target clusters are greater than degrees of congestion at time periods included in the rest clusters; a determination module, configured to determine a peak period based on the time periods included in the target clusters; and a control module, configured to, control the traffic signals during the peak period by using a signal control configuration corresponding to the peak period.

Embodiments of a third aspect of the present disclosure provide a computer device including at least one processor, and a storage device communicatively connected to the at least one processor. The storage device stores an instruction executable by the at least one processor. The instruction is executed by the at least one processor to enable the at least one processor to perform the method for controlling traffic signals according to embodiments of the first aspect of the present disclosure.

Embodiments of a fourth aspect of the present disclosure provide a non-transitory computer-readable storage medium having a computer instruction stored thereon. The computer instruction is configured to cause a computer to perform the method for controlling traffic signals according to embodiments of the first aspect of the present disclosure.

### BRIEF DESCRIPTION OF THE DRAWINGS

The accompanying drawings are used for a better understanding of the solution, and do not constitute a limitation of the present disclosure. The above and/or additional aspects and advantages of the present disclosure will become apparent and easy to be understood from the following description of the embodiments in combination with the drawings.

FIG. 1 is a flowchart of a method for controlling traffic signals according to embodiment 1 of the present disclosure.

FIG. 2 is a flowchart of a method for controlling traffic signals according to embodiment 2 of the present disclosure.

FIG. 3 is a flowchart of a method for controlling traffic signals according to embodiment 3 of the present disclosure.

FIG. 4 is a schematic diagram of a relationship between J and K.

FIG. 5 is a schematic diagram of an apparatus for controlling traffic signals according to embodiment 4 of the present disclosure.

FIG. 6 is a schematic diagram of an apparatus for controlling traffic signals according to embodiment 5 of the present disclosure.

FIG. 7 is a block diagram of a computer device according to embodiment 6 of the present disclosure.

### DETAILED DESCRIPTION

Exemplary embodiments of the present disclosure are described below with reference to the accompanying drawings, which include various details of the embodiments of the present disclosure to facilitate understanding, and should be considered as merely exemplary. Therefore, those skilled in the art should recognize that various changes and modifications may be made to the embodiments described herein without departing from the scope and spirit of the present disclosure. Also, for clarity and conciseness, descriptions of well-known functions and structures are omitted in the following description.

A method for controlling traffic signals and apparatus, a computer device and a storage medium according to embodiments of the present disclosure are described below with reference to the drawings.

FIG. 1 is a flowchart of a method for controlling traffic signals according to embodiment 1 of the present disclosure.

The embodiment of the present disclosure takes the method for controlling traffic signals being configured in the apparatus for controlling traffic signals as an example for description. The apparatus for controlling traffic signals may be applied to any computer device, so that the computer device may perform the function of controlling a traffic signal.

The computer device may be a personal computer (PC), a cloud device, a mobile device, and so on. The mobile device may be any hardware device having an operating system, a touch screen and/or a display screen, for example, a mobile phone, a tablet computer, a personal digital assistant, a wearable device, and a vehicle-mounted device.

As illustrated in FIG. 1, the method for controlling traffic signals may include the following steps.

At block 101, degrees of congestion detected at an intersection at respective time periods are obtained.

In the embodiment of the present disclosure, each time period is pre-divided. In detail, the length of time of each time period is preset. For example, the length of time of each time period may be preset to 15 minutes (min). For example, the time periods obtained through pre-division may be: 0:00:00-0:15:00, 0:15:00-0:30:00, 0:30:00-0:45:00, . . . , 23:30:00-23:45:00, 23:45:00-00:00:00.

In the embodiment of the present disclosure, the degrees of congestion may be characterized by traffic and delay time of a vehicle passing through the intersection, and may be determined by images captured by cameras provided at an entrance and an exit of the intersection. For each time period, the traffic in the time period may be directly determined based on images captured by the cameras during the time period. It should be understood that, in each time period, the delay time of the vehicle passing through the intersection may be determined based on a difference between an actual passing time for the vehicle to pass through the intersection and a time for the vehicle to pass through the intersection without stopping. The actual passing time for the vehicle to pass through the intersection may be based on a difference between a first time point when the vehicle enters an image captured by a first camera installed at the entrance of the intersection and a second time point when the vehicle exits an image captured by a second camera installed at the exit of the intersection.

At block 102, the time periods are clustered based on the degrees of congestion to obtain a plurality of clusters.

In the embodiment of the present disclosure, a number of clusters may be determined based on a clustering algorithm. It should be understood that an optimization goal of the clustering algorithm is to minimize a sum of distances from each piece of sample data in each cluster to a cluster center, and to minimize a degree of difference (which may also be called an intra-class dispersion, or an intra-class diameter) in data within each cluster. Therefore, in the present disclosure, when an internal discreteness within clusters indicates that the differences in the degrees of congestion at respective time periods in the same cluster is the smallest, the number of corresponding clusters may be determined by using the clustering algorithm, and the determined number of clusters is taken as a number of the target clusters.

For example, when the number of clusters is 2, the internal discreteness within the clusters indicates that the differences in the degrees of congestion at respective time periods in the same cluster is greater than the corresponding differences when the number of clusters is 3, and when the number of clusters is 3, the internal discreteness within the clusters indicates that the differences in the degrees of congestion at respective time periods within the same cluster is less than the corresponding degree of difference when the number of clusters is 4, the number 3 may be used as the number of target clusters. That is to say, when the differences in data within each cluster is the smallest, the corresponding number of clusters may be used as the number of target clusters, that is, when the degree of difference between the degrees of congestion at respective time periods in each cluster is the smallest, the corresponding number of clusters is determined as the number of target clusters.

In the embodiment of the present disclosure, when determining the number of target clusters, the time periods may be clustered based on the delay time to obtain respective clusters, or the time periods may be clustered based on the traffic to obtain respective clusters.

At block 103, target clusters may be determined from the plurality of clusters based on the degrees of congestion. Degrees of congestion at time periods included in the target clusters are greater than degrees of congestion at time periods included in the rest clusters.

In the embodiment of the present disclosure, after each cluster is obtained by performing clustering based on the delay time, the cluster with the longest average delay time may be determined as the target cluster. After each cluster is obtained by performing clustering based on the traffic, the cluster with the largest average traffic may be determined as the target cluster.

At block 104, a peak period is determined based on the time periods included in the target clusters.

In the embodiment of the present disclosure, a time period that is an intersection of the time periods in the target clusters may be determined as the peak period.

For example, if time periods in the cluster with the largest average traffic are time periods from the 4th time period to the 11th time period, and time periods in the cluster with the longest average delay are time periods from the 3rd time period to the 10th time period, the third time period to the tenth time period may be used as the peak period. Consequently, it may be determined that the peak period within a day is from the third time period to the tenth time period.

At block 105, the traffic signals during the peak period is controlled by using a signal control configuration corresponding to the peak period.

In the embodiment of the present disclosure, the signal control configuration corresponding to the peak period may be any signal control configuration adopted in the peak period in the related art, and there is no restriction in this regard. For example, the signal control configuration corresponding to the peak period may include: prolonging the display time of a green traffic light when a vehicle passes the intersection, shortening the display time of a red traffic light when a vehicle is waiting, and so on.

In the embodiment of the present disclosure, after the peak period is determined, the signal control configuration corresponding to the peak period may be adopted to control the traffic signal. Therefore, by determining the peak period within a day based on the degrees of congestion of the intersection, the accuracy of the determination result may be improved. In addition, the degrees of congestion at the intersection at different time periods may be clustered based on a software algorithm to automatically recognize the peak period, without relying on human experience to divide the time periods. Consequently, on the one hand, the accuracy of recognition results may be improved, and on the other hand, labor costs may be saved. Further, the technical problem of inaccurate division results in the prior art that may be generated from time segmentation performed on a basis of manual experience, may be solved.

According to the method for controlling traffic signals according to the embodiment of the present disclosure, the degrees of congestion detected at an intersection at respective time periods are obtained. The time periods are clustered based on the degrees of congestion to obtain a plurality of clusters. The target clusters are determined from the plurality of clusters based on the degrees of congestion, in which degrees of congestion at time periods included in the target clusters are greater than degrees of congestion at time periods included in the rest clusters. A peak period is determined based on the time periods included in the target clusters. In the peak period, traffic signal control is performed by using a signal control configuration corresponding to the peak period. Consequently, determining the final peak period based on the degrees of congestion at the intersection may improve the accuracy of a determined result. In addition, the degrees of congestion at the intersection at different time periods may be clustered based on a software algorithm to automatically recognize the peak period, without relying on human experience to divide the time periods. Consequently, on the one hand, the accuracy of recognition results may be improved, and on the other hand, labor costs may be saved.

It should be noted that the degree of congestion is characterized by the traffic and the delay time of a vehicle passing through the intersection, and the traffic and the delay time may be different at different time points. Therefore, each time period may have more than one sampling point of the degree of congestion. For example, each time point may be used as a sampling point. Therefore, as a possible implementation, at block 102, for each time period, relationship curves of time and the degrees of congestion may be generated based on the degrees of congestion detected by the more than one sampling points, and more than one clusters may be obtained after clustering respective time periods based on a similarity between the relationship curves. The above process will be described in detail below in combination with embodiment 2.

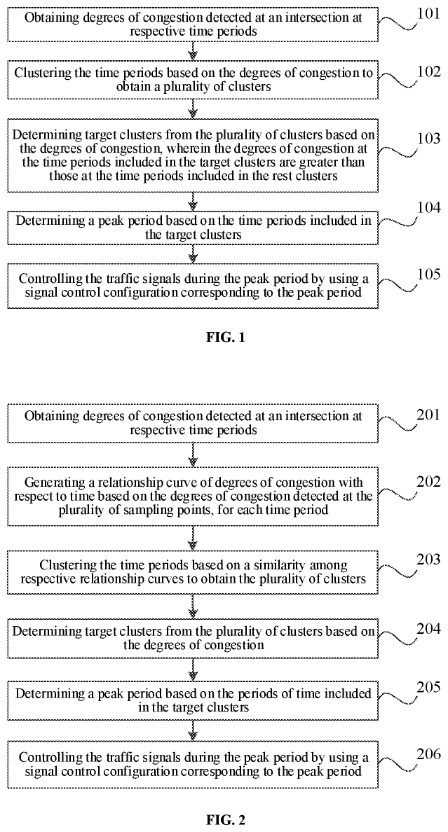

FIG. 2 is a flowchart of a method for controlling traffic signals according to embodiment 2 of the present disclosure.

As illustrated in FIG. 2, the method for controlling traffic signals may include the following.

At block 201, degrees of congestion detected at an intersection at respective time periods are obtained.

The execution process of block 201 may be referred to the execution process of block 101 in the foregoing embodiment, and details will not be described herein again.

At block 202, a relationship curve of degrees of congestion with respect to time is generated based on the degrees of congestion detected at the plurality of sampling points, for each time period.

In the embodiment of the present disclosure, the degrees of congestion are characterized by traffic and delay time of a vehicle passing through the intersection. A relationship curve of degrees of congestion with respect to time is generated based on the degrees of congestion detected at the plurality of sampling points, for each time period, and the relationship curve of time and delay time is generated based on the delay time detected at the plurality of sampling points.

For example, each time point may be used as a sampling point to monitor delay time D of a vehicle passing through the intersection at each time point within 24 hours of a day. A relationship curve D-T of the delay time D and time may be drawn, where the abscissa represents the time, and the ordinate represents the delay time D. Correspondingly, it is possible to monitor traffic Q of the intersection at each time point within 24 hours of a day, and a relationship curve Q-T between the traffic Q and time may be drawn, where the abscissa represents the time, and the ordinate represents the traffic Q. After that, the relationship curves D-T and Q-T may be divided by a time interval of, for example, 15 minutes, to obtain several relationship curves. For example, relationship curves between the delay time and the time obtained after the division are: D-T₁, D-T₂, D-T₃, and so on, and relationship curves between the traffic and the time are: Q-T₁, Q-T₂, Q-T₃, and so on.

At block 203, the time periods are clustered based on a similarity between respective relationship curves to obtain the plurality of clusters.

In the embodiment of the present disclosure, after respective relationship curves are generated, the time periods may be clustered based on the similarity between the relationship curves to obtain the plurality of clusters. For example, characteristics of each relationship curve may be extracted separately, where the characteristics include an inflection point, a slope, and so on. The similarity between the relationship curves may be calculated based on the characteristics of each relationship curve. After the similarity between the relationship curves are calculated, the time periods may be clustered based on the similarity so as to obtain the plurality of clusters.

In detail, clustering may be performed based on the similarity between the relationship curves of the time periods and the traffic to obtain clusters obtained by clustering of the traffic. Still, take the above example as an example. Each cluster may be obtained by clustering Q-T₁, Q-T₂, Q-T₃, and so on, based on the similarity between Q-T₁, Q-T₂, Q-T₃, and so on. Clustering may be performed based on the similarity between the relationship curves of the time periods and the delay time to obtain clusters obtained by clustering of the delay time. Still, take the above example as an example. Each cluster may be obtained by clustering D-T₁, D-T₂, D-T₃, and so on, based on the similarity between D-T₁, D-T₂, D-T₃, and so on.

At block 204, target clusters are determined from the plurality of clusters based on the degrees of congestion.

In the embodiment of the present disclosure, the cluster with the longest average delay time among the clusters obtained by clustering based on the delay time may be determined as the target cluster, and the cluster with the largest average traffic among the clusters obtained by clustering based on the traffic may be determined as the target cluster.

At block 205, a peak period is determined based on the time periods included in the target clusters.

In the embodiment of the present disclosure, a time period that is an intersection of the time periods in the target clusters may be determined as the peak period.

At block 206, in the peak period, traffic signal control is performed by using a signal control configuration corresponding to the peak period.

For the execution process of block 206, reference may be made to the execution process of block 105 in the foregoing embodiment, and thus details will not be described herein again.

With the method for controlling traffic signals according to the embodiment of the present disclosure, for each time period, a relationship curve of degrees of congestion with respect to time is generated based on the degrees of congestion detected at the plurality of sampling points. The time periods are clustered based on a similarity among respective relationship curves to obtain the plurality of clusters. The target clusters are determined from the plurality of clusters based on the degrees of congestion. The peak period is determined based on the time periods included in the target clusters. Consequently, the accuracy of the determination of the peak period may be improved.

As a possible implementation, before clustering each time period to obtain the plurality of clusters, the number of clusters needs to be determined. In the present disclosure, the number of target clusters may be determined based on a correlation between the number of the clusters and an internal discreteness within the clusters, by using an inflection-point method. The internal discreteness within the clusters is determined based on differences in the degrees of congestion at respective time periods in the same cluster. The above process will be described in detail below in combination with embodiment 3.

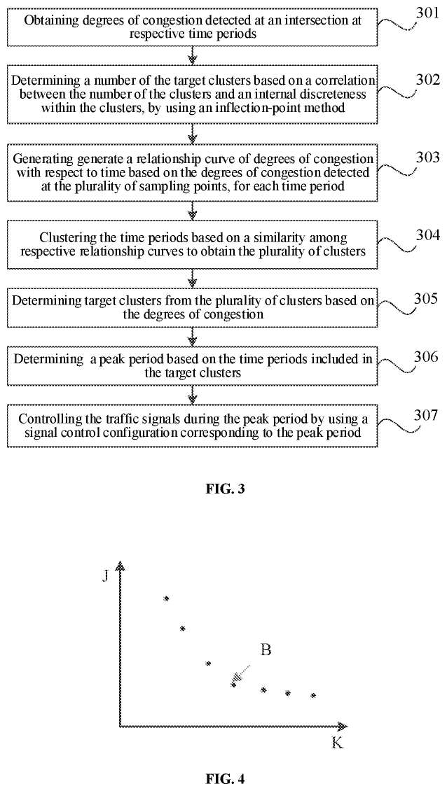

FIG. 3 is a flowchart of a method for controlling traffic signals according to embodiment 3 of the present disclosure.

As illustrated in FIG. 3, the method for controlling traffic signals may include the following.

At block 301, degrees of congestion detected at an intersection at respective time periods are obtained.

In the embodiment of the present disclosure, the degrees of congestion are characterized by the traffic and the delay time of the vehicle passing through the intersection.

As for the delay time of the vehicle passing through the intersection, a difference between a time for the vehicle to pass through the intersection that is detected at a respective time period and a set time may be determined as the delay time. The set time is the time for the vehicle to pass through the intersection without stopping.

In the embodiment of the present disclosure, the time for the vehicle to pass through the intersection, that is, the actual passing time for the vehicle to pass through the intersection, may be determined based on the difference between the first time point when the vehicle enters an image captured by the first camera installed at the entrance of the intersection and the second time point when the vehicle exits an image captured by the second camera installed at the exit of the intersection. In detail, the first camera and the second camera may capture images in real time. When a vehicle enters the entrance of the intersection, the first camera may capture a vehicle drive-in image including the vehicle. The vehicle drive-in image indicates that it is the first time the vehicle enters a range of shooting of the first camera within a preset time period. Therefore, an image where the vehicle appears for the first time in images captured by the first camera within the preset time period may be determined as a corresponding vehicle drive-in image, and a time point of capturing the vehicle drive-in image is determined as a passing time point of the vehicle, which is recorded as the first time point in the present disclosure. Similarly, when the vehicle travels from the entrance to the exit of the intersection, images continuously captured by the second camera may include the vehicle. When the vehicle exits the exit, the vehicle may be out of a range of shooting of the second camera after the second camera continuously collects images including the vehicle for several times. Consequently, the last image including the vehicle in images continuously captured by the second camera when the vehicle is within the range of shooting of the second camera may be determined as a vehicle drive-out image, and a time point of capturing the vehicle drive-out image is determined as a passing time point of the vehicle, which is recorded as the second time point in the present disclosure.

For example, when vehicle A enters an entrance of an intersection 1 for the first time on a day, the first image including vehicle A captured by the first camera at the entrance of the intersection 1 on the day may be determined as the vehicle drive-in image, and the time point of capturing the vehicle drive-in image may be determined as the first time point. When vehicle A exits the exit of the intersection 1, the last image including vehicle A before the first image that does not include vehicle A after the second camera at the exit of the intersection 1 continuously captures images including vehicle A may be determined as the vehicle drive-out image, and the time point of capturing the vehicle drive-out image may be determined as the second time point.

It should be understood that since there are few vehicles driving on the road at night, traffic jams seldom occur. Therefore, in the present disclosure, in order to improve the accuracy of calculation results, a time for a vehicle to pass through the intersection at night without stopping may be determined as the set time. For example, the time for a vehicle to pass through the intersection without stopping from 00:00 to 6:00 in the morning may be determined as the set time.

At block 302, a number of the target clusters is determined based on a correlation between the number of the clusters and an internal discreteness within the clusters, by using an inflection-point method.

The internal discreteness within the clusters is determined based on differences in the degrees of congestion at respective time periods in the same cluster.

As a possible implementation, when clustering, the number of clusters may be determined based on degrees of difference between samples. In detail, in order to determine a peak period within a day, the degrees of congestion (delay time and traffic) within a day may be divided by a time interval of, for example, 15 minutes, to obtain a degree of congestion corresponding to each time period. For example, when the time interval is 15 minutes, 24*60/15=96 time periods may be obtained. The number of time periods is marked as N, and thus a sequence of degrees of congestion obtained may be marked as A={X₁, X₂, X₃, . . . , X_{N}}. Assume that data samples included in class G obtained by clustering is {Xᵢ, Xᵢ₊₁, Xᵢ₊₂, . . . , Xⱼ}, where 1≤i≤j≤SN. For sequence A of degrees of congestion, the degree of difference of data within the sequence after clustering, that is, the intra-class dispersion, may be measured by the intra-class diameter. The intra-class diameter is D(i, j)=|Xₜ−E_{G}|, t=(i, i+1, . . . , j), where E_{G} is an average of all data samples in the class G.

It should be understood that when the intra-class diameter D(i, j) is the smallest, it means that the degree of difference between the degrees of congestion in each time period in the same cluster is relatively small, and the clustering effect is satisfying. Therefore, the final number of clusters may be determined based on the value of the intra-class diameter. That is to say, the number of clusters having the smallest degree of difference between data within the clusters may be determined as the number of the target clusters, that is, the number of clusters having the smallest difference between the degrees of congestion at respective time periods in the clusters may be determined as the number of target clusters.

Further, in order to improve the clustering effect, degrees of congestion of n days may be obtained. For each time period of n days, degrees of congestion of the same time period may be averaged, and a corresponding intra-class diameter may be calculated based on degrees of congestion at respective time periods obtained after the average processing.

As another possible implementation, when clustering, the number of clusters may also be determined based on a sum of distances from each sample to a cluster center. In detail, for the sequence of degrees of congestion A={X₁, X₂, X₃, . . . , X_{N}}, the cluster center to which Xi belongs is μ_{c}_{ᵢ} after clustering. During the clustering process, a point with the smallest distance to each piece of sample data Xᵢ will be searched and determined as the cluster center. The optimization goal of the clustering algorithm is:

$$J ( {c}_{1} , L , {c}_{N} , {μ}_{1} , L , {μ}_{k} ) = \frac{1}{N} {\sum }_{1}^{N} ( ‖ {X}_{i} - {μ}_{{c}_{i}} ‖ ) ; \qquad ( 1 )$$

where cᵢ represents the subscript of the closest cluster center, μₖ represents the cluster center, and the value of the optimization target J represents a sum of distances from each piece of sample data to the cluster center. Therefore, when J is the smallest J, the clustering error is the smallest. Different values of the number K of clusters generate different values of J. It is generally believed that the number of clusters may take the value of an inflection point on J-K. For example, referring to FIG. 4, a schematic diagram of the relationship between J and K, in order to minimize the degree of difference between the degrees of congestion in each time period in the same cluster, that is, to minimize the value of J, the value of K at point B in FIG. 4 may be determined as the final number of target clusters.

In other words, in order to obtain the optimal partition value, the number of target clusters may be determined by the inflection-point method, and K corresponding to the “inflection point” in the trend graph of a target function is defined as the optimal partition value. A loss function is a typical concave function having a slope monotonically negatively related to K, and a most significant rate of change at the inflection point. To this end, the above problem is transformed into an optimization problem, that is, a dispersion slope of the optimal partition loss value under any two adjacent K is calculated, K at the position of an abrupt change of the slope is the optimal partition number Kₒₚ, dispersion slopes corresponding to K-th partition and (K+1)th partition are let to be tan K, and change rates of two consecutive slopes before and after K-th partition and (K+1)th partition are let to be Diff, and thus:

$$Diff = \vert \frac{tan k - tan ( k - 1 )}{tan k - tan ( k + 1 )} \vert \qquad ( 2 )$$

Consequently, the optimal partition number, that is, the number of target clusters Kₒₚ may be: max{Diff (K)}.

At block 303, a relationship curve of degrees of congestion with respect to time is generated based on the degrees of congestion detected at the plurality of sampling points, for each time period.

In the embodiment of the present disclosure, after the number of target clusters is determined, for each time period, the relationship curve of degrees of congestion with respect to time may be generated based on the degrees of congestion detected at the plurality of sampling points. The specific implementation process of block 303 may be referred to the execution process of block 202 in the above embodiment, and thus will not be repeated here.

At block 304, the time periods are clustered based on a similarity between respective relationship curves to obtain the plurality of clusters.

The execution process of block 304 may be referred to the execution process of block 203 in the foregoing embodiment, and thus will not be repeated here.

At block 305, target clusters are determined from the plurality of clusters based on the degrees of congestion.

At block 306, a peak period is determined based on the time periods included in the target clusters.

Execution processes of blocks 305 to 306 may be referred to the execution processes of blocks 204 to 205 in the foregoing embodiment, and thus will not be repeated here.

At block 307, in the peak period, traffic signal control is performed by using a signal control configuration corresponding to the peak period.

The execution process of block 307 may be referred to the execution process of block 105 in the foregoing embodiment, and thus will not be repeated herein.

As an application scenario, for intersection A, (1) the time for a vehicle to pass through intersection A without stopping from 00:00 to 6:00 in the morning may be determined as the set time. (2) The actual passing time for a vehicle to pass through the intersection at each time period within 24 hours of a day may be detected within 24 hours of a day, and a difference between the actual passing time and the set time may be determined as the delay time D at a corresponding time point. A relationship curve D-T of the delay time D and time may be drawn, where the abscissa represents the time, and the ordinate represents the delay time D. (3) Traffic Q of the intersection at each time point within 24 hours of a day may be detected, and a relationship curve Q-T between the traffic Q and time may be drawn, where the abscissa represents the time, and the ordinate represents the traffic Q. (4) The relationship curve D-T and the relationship curve Q-T are respectively divided into several segments by a time interval of, such as a unit of duration of 15 minutes. According to curve a similarity between the segments, clustering is performed to obtain clusters of the curves. (5) Among the clusters obtained based on the clustering of the delay time D, the cluster with the longest average delay time may be determined as a curve cluster corresponding to a peak period in the relationship curve D-T, and among the clusters obtained based on the clustering of the traffic Q, the cluster with the largest average traffic may be determined as a curve cluster corresponding to a peak period in the relationship curve Q-T. (6) An intersection of time of the curve cluster corresponding to a peak period in the relationship curve D-T and the curve cluster corresponding to a peak period in the relationship curve Q-T may be calculated, and a time period of the intersection of time may be determined as the finally determined peak period. (7) In the peak period, traffic signal control is performed on intersection A by using a signal control configuration corresponding to the peak period.

It should be understood that for each intersection, the control method provided by the present disclosure may be used to determine the corresponding peak period, so that the signal control configuration corresponding to the peak period may be adopted to control traffic signals at the corresponding intersection, thereby improving applicability of the method.

With the method for controlling traffic signals according to the embodiment of the present disclosure, the number of target clusters may be determined based on a correlation between the number of the clusters and an internal discreteness within the clusters, by using an inflection-point method. The internal discreteness within the clusters is determined based on differences in the degrees of congestion at respective time periods in the same cluster. Consequently, the clustering effect may be improved, thereby improving the accuracy of the determination of the peak period.

To achieve the above embodiments, the present disclosure further provides an apparatus for controlling traffic signals.

FIG. 5 is a schematic diagram of an apparatus for controlling traffic signals according to embodiment 4 of the present disclosure.

As illustrated in FIG. 5, an apparatus for controlling traffic signals 500 includes an obtaining module 510, a clustering module 520, a selection module 530, a determination module 540 and a control module 550.

The obtaining module 510 is configured to obtain degrees of congestion detected at an intersection at respective time periods. The clustering module 520 is configured to cluster the time periods based on the degrees of congestion to obtain a plurality of clusters. The selection module 530 is configured to determine target clusters from the plurality of clusters based on the degrees of congestion. Degrees of congestion at time periods included in the target clusters are greater than degrees of congestion at time periods included in the rest clusters. The determination module 540 is configured to determine a peak period based on the time periods included in the target clusters. The control module 550 is configured to, control the traffic signals during the peak period by using a signal control configuration corresponding to the peak period.

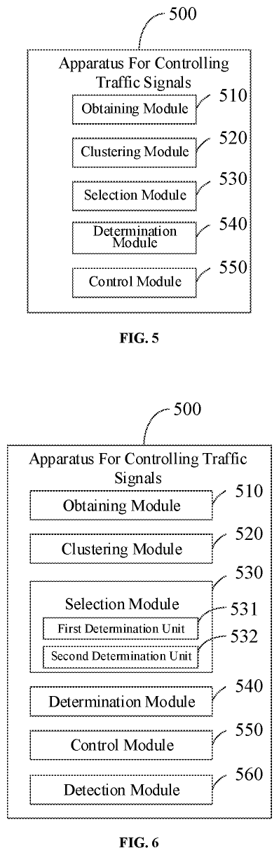

Further, in a possible implementation of embodiments of the present disclosure, referring to FIG. 6, and on the basis of the embodiment illustrated in FIG. 5, the apparatus for controlling traffic signals 500 further includes a detection module 560.

As a possible implementation, the degrees of congestion are characterized by traffic and delay time of vehicles passing through the intersection. The selection module 530 includes a first determination unit 531 and a second determination unit 532. The first determination unit 531 is configured to, in clusters obtained by clustering based on the delay time, determine a cluster with the longest average delay time as a target cluster. The second determination unit 532 is configured to, in clusters obtained by clustering based on the traffic, determine a cluster with the largest average traffic as a target cluster. The determination module 540 is specifically configured to determine a time period that is an intersection of the time periods in the target clusters, as the peak period.

As a possible implementation, the obtaining module 510 is specifically configured to determine a difference between a time for the vehicle to pass through the intersection that is detected at a respective time period and a set time, as the delay time. The set time is a time for the vehicle to pass through the intersection without stopping.

The detection module 560 is configured to determine a time for a vehicle to pass through the intersection at night without stopping as the set time.

As a possible implementation, the determination module 540 is further configured to determine a number of the target clusters based on a correlation between the number of the clusters and an internal discreteness within the clusters, by using an inflection-point method. The discreteness within the clusters is determined based on differences in degrees of congestion at respective time periods in the same cluster.

As a possible implementation, a plurality of sampling points of the degrees of congestion are provided in each time period. The clustering module 520 is specifically configured to generate a relationship curve of degrees of congestion with respect to time based on the degrees of congestion detected at the plurality of sampling points, for each time period; and to cluster the time periods based on a similarity among respective relationship curves to obtain the plurality of clusters.

It should be noted that the foregoing explanations of the method for controlling traffic signals in embodiments of FIGS. 1 to 3 are also applicable to the apparatus for controlling traffic signals in this embodiment, and details will not be described here.

According to the apparatus for controlling traffic signals according to the embodiment of the present disclosure, the degrees of congestion detected at an intersection at respective time periods are obtained. The time periods are clustered based on the degrees of congestion to obtain a plurality of clusters. The target clusters are determined from the plurality of clusters based on the degrees of congestion, in which degrees of congestion at time periods included in the target clusters are greater than degrees of congestion at time periods included in the rest clusters. A peak period is determined based on the time periods included in the target clusters. In the peak period, traffic signal control is performed by using a signal control configuration corresponding to the peak period. Consequently, determining the final peak period based on the degrees of congestion at the intersection may improve the accuracy of a determined result. In addition, the degrees of congestion at the intersection at different time periods may be clustered based on a software algorithm to automatically recognize the peak period, without relying on human experience to divide the time periods. Consequently, on the one hand, the accuracy of recognition results may be improved, and on the other hand, labor costs may be saved.

To implement the above embodiments, the present disclosure further provides a computer device including at least one processor, and a storage device communicatively connected to the at least one processor. The storage device stores an instruction executable by the at least one processor. The instruction is executed by the at least one processor to enable the at least one processor to perform the method for controlling traffic signals according to the above embodiments of the present disclosure.

To implement the above embodiments, the present disclosure further provides a non-transitory computer-readable storage medium having a computer instruction stored thereon. The computer instruction is configured to cause a computer to perform the method for controlling traffic signals according to the above embodiments of the present disclosure.

According to embodiments of the present disclosure, the present disclosure further provides a computer device and a readable storage medium.

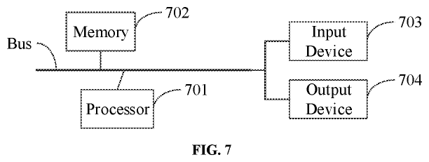

FIG. 7 is a block diagram of a computer device for implementing a method for controlling traffic signals according to an embodiment of the present disclosure. The computer device is intended to represent various forms of digital computers, such as a laptop computer, a desktop computer, a workbench, a personal digital assistant, a server, a blade server, a mainframe computer and other suitable computers. The computer device may also represent various forms of mobile devices, such as a personal digital processor, a cellular phone, a smart phone, a wearable device and other similar computing devices. Components shown herein, their connections and relationships as well as their functions are merely examples, and are not intended to limit the implementation of the present disclosure described and/or required herein.

As illustrated in FIG. 7, the computer device includes: one or more processors 701, a memory 702, and interfaces for connecting various components, including a high-speed interface and a low-speed interface. The components are interconnected by different buses and may be mounted on a common motherboard or otherwise installed as required. The processor may process instructions executed within the computer device, including instructions stored in or on the memory to display graphical information of the GUI on an external input/output device (such as a display device coupled to the interface). In other embodiments, when necessary, multiple processors and/or multiple buses may be used with multiple memories. Similarly, multiple computer devices may be connected, each providing some of the necessary operations (for example, as a server array, a group of blade servers, or a multiprocessor system). One processor 701 is taken as an example in FIG. 7.

The memory 702 is a non-transitory computer-readable storage medium according to the embodiments of the present disclosure. The memory stores instructions executable by at least one processor, so that the at least one processor executes the method for controlling traffic signals according to embodiments of the present disclosure. The non-transitory computer-readable storage medium according to the present disclosure stores computer instructions, which are configured to make the computer execute the method for controlling traffic signals according to embodiments of the present disclosure.

As a non-transitory computer-readable storage medium, the memory 702 may be configured to store non-transitory software programs, non-transitory computer executable programs and modules, such as program instructions/modules (for example, the obtaining module 510, the clustering module 520, the selection module 530, the determination module 540 and the control module 550 illustrated in FIG. 5) corresponding to the method for controlling traffic signals according to the embodiment of the present disclosure. The processor 701 executes various functional applications and performs data processing of the server by running non-transitory software programs, instructions and modules stored in the memory 702, that is, the method for controlling traffic signals according to the foregoing method embodiments is implemented.

The memory 702 may include a storage program area and a storage data area, where the storage program area may store an operating system and applications required for at least one function; and the storage data area may store data created according to the use of the computer device, and the like. In addition, the memory 702 may include a high-speed random access memory, and may further include a non-transitory memory, such as at least one magnetic disk memory, a flash memory device, or other non-transitory solid-state memories. In some embodiments, the memory 702 may optionally include memories remotely disposed with respect to the processor 701, and these remote memories may be connected to the computer device through a network. Examples of the network include, but are not limited to, the Internet, an intranet, a local area network, a mobile communication network, and combinations thereof.

The computer device may further include an input device 703 and an output device 704. The processor 701, the memory 702, the input device 703 and the output device 704 may be connected through a bus or in other manners. FIG. 7 is illustrated by establishing the connection through a bus.

The input device 703 may receive input numeric or character information, and generate key signal inputs related to user settings and function control of the computer device configured to implement the method for controlling traffic signals according to the embodiments of the present disclosure, such as a touch screen, a keypad, a mouse, a trackpad, a touchpad, a pointing stick, one or more mouse buttons, trackballs, joysticks and other input devices. The output device 704 may include a display device, an auxiliary lighting device (for example, an LED), a haptic feedback device (for example, a vibration motor), and so on. The display device may include, but is not limited to, a liquid crystal display (LCD), a light emitting diode (LED) display and a plasma display. In some embodiments, the display device may be a touch screen.

Various implementations of systems and technologies described herein may be implemented in digital electronic circuit systems, integrated circuit systems, application-specific ASICs (application-specific integrated circuits), computer hardware, firmware, software, and/or combinations thereof. These various implementations may include: being implemented in one or more computer programs that are executable and/or interpreted on a programmable system including at least one programmable processor. The programmable processor may be a dedicated or general-purpose programmable processor that may receive data and instructions from a storage system, at least one input device and at least one output device, and transmit the data and instructions to the storage system, the at least one input device and the at least one output device.

These computing programs (also known as programs, software, software applications, or codes) include machine instructions of a programmable processor, and may implement these calculation procedures by utilizing high-level procedures and/or object-oriented programming languages, and/or assembly/machine languages. As used herein, terms “machine-readable medium” and “computer-readable medium” refer to any computer program product, device and/or apparatus configured to provide machine instructions and/or data to a programmable processor (for example, a magnetic disk, an optical disk, a memory and a programmable logic device (PLD)), and includes machine-readable media that receive machine instructions as machine-readable signals. The term “machine-readable signals” refers to any signal used to provide machine instructions and/or data to a programmable processor.

In order to provide interactions with the user, the systems and technologies described herein may be implemented on a computer having: a display device (for example, a cathode ray tube (CRT) or a liquid crystal display (LCD) monitor) for displaying information to the user; and a keyboard and a pointing device (such as a mouse or trackball) through which the user may provide input to the computer. Other kinds of devices may also be used to provide interactions with the user; for example, the feedback provided to the user may be any form of sensory feedback (e.g., visual feedback, auditory feedback or haptic feedback); and input from the user may be received in any form (including acoustic input, voice input or tactile input).

The systems and technologies described herein may be implemented in a computing system that includes back-end components (for example, as a data server), a computing system that includes middleware components (for example, an application server), or a computing system that includes front-end components (for example, a user computer with a graphical user interface or a web browser, through which the user may interact with the implementation of the systems and technologies described herein), or a computing system including any combination of the back-end components, the middleware components or the front-end components. The components of the system may be interconnected by digital data communication (e.g., a communication network) in any form or medium. Examples of the communication network include: a local area network (LAN), a wide area network (WAN), and the Internet.

Computer systems may include a client and a server. The client and server are generally remote from each other and typically interact through the communication network. A client-server relationship is generated by computer programs running on respective computers and having a client-server relationship with each other.

With the technical solution according to embodiments of the present disclosure, the degrees of congestion detected at an intersection at respective time periods are obtained. The time periods are clustered based on the degrees of congestion to obtain a plurality of clusters. The target clusters are determined from the plurality of clusters based on the degrees of congestion, in which degrees of congestion at time periods included in the target clusters are greater than degrees of congestion at time periods included in the rest clusters. A peak period is determined based on the time periods included in the target clusters. In the peak period, traffic signal control is performed by using a signal control configuration corresponding to the peak period. Consequently, determining the final peak period based on the degrees of congestion at the intersection may improve the accuracy of a determined result. In addition, the degrees of congestion at the intersection at different time periods may be clustered based on a software algorithm to automatically recognize the peak period, without relying on human experience to divide the time periods. Consequently, on the one hand, the accuracy of recognition results may be improved, and on the other hand, labor costs may be saved.

It should be understood that various forms of processes shown above may be reordered, added or deleted. For example, the blocks described in the present disclosure may be executed in parallel, sequentially, or in different orders. As long as the desired results of the technical solution disclosed in the present disclosure may be achieved, there is no limitation herein.

The foregoing specific implementations do not constitute a limit on the protection scope of the present disclosure. It should be understood by those skilled in the art that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for controlling traffic signals, comprising:
obtaining degrees of congestion detected at an intersection at respective time periods;
clustering the time periods based on the degrees of congestion to obtain a plurality of clusters;
determining target clusters from the plurality of clusters based on the degrees of congestion, wherein the degrees of congestion at the time periods included in the target clusters are greater than those at the time periods included in the rest clusters;
determining a peak period based on the time periods included in the target clusters; and
controlling the traffic signals during the peak period by using a signal control configuration corresponding to the peak period.

2. The method for controlling traffic signals of claim 1, wherein the degrees of congestion are characterized by traffic and delay time of a vehicle passing through the intersection, and determining the target clusters from the plurality of clusters based on the degrees of congestion comprises:
determining a cluster with the longest average delay time among the clusters obtained by clustering based on the delay time, as the target cluster; and
determining a cluster with the largest average traffic among the clusters obtained by clustering based on the traffic, as the target cluster, and
wherein, determining the peak period based on the time periods included in the target clusters comprises:
determining a time period that is an intersection of the time periods in the target clusters as the peak period.

3. The method for controlling traffic signals of claim 2, wherein obtaining the degrees of congestion detected at the intersection at respective time periods comprises:
determining a difference between a time for the vehicle to pass through the intersection that is detected at a respective time period and a set time, as the delay time,
wherein the set time is a time for the vehicle to pass through the intersection without stopping.

4. The method for controlling traffic signals of claim 3, further comprising:
determining a time for a vehicle to pass through the intersection at night without stopping as the set time.

5. The method for controlling traffic signals of claim 1, further comprising:
determining a number of the target clusters based on a correlation between the number of the clusters and an internal discreteness within the clusters, by using an inflection-point method,
wherein, the internal discreteness within the clusters is determined based on differences in the degrees of congestion at respective time periods in the same cluster.

6. The method for controlling traffic signals of claim 2, further comprising:
determining a number of the target clusters based on a correlation between the number of the clusters and an internal discreteness within the clusters, by using an inflection-point method,
wherein, the internal discreteness within the clusters is determined based on differences in the degrees of congestion at respective time periods in the same cluster.

7. The method for controlling traffic signals of claim 3, further comprising:
determining a number of the target clusters based on a correlation between the number of the clusters and an internal discreteness within the clusters, by using an inflection-point method,
wherein, the internal discreteness within the clusters is determined based on differences in the degrees of congestion at respective time periods in the same cluster.

8. The method for controlling traffic signals of claim 4, further comprising:
determining a number of the target clusters based on a correlation between the number of the clusters and an internal discreteness within the clusters, by using an inflection-point method,
wherein, the internal discreteness within the clusters is determined based on differences in the degrees of congestion at respective time periods in the same cluster.

9. The method for controlling traffic signals of claim 1, wherein a plurality of sampling points for the degrees of congestion are provided in each time period, and clustering the time periods based on the degrees of congestion to obtain the plurality of clusters comprises:
generating a relationship curve of degrees of congestion with respect to time based on the degrees of congestion detected at the plurality of sampling points, for each time period; and
clustering the time periods based on a similarity among respective relationship curves to obtain the plurality of clusters.

10. The method for controlling traffic signals of claim 2, wherein a plurality of sampling points for the degrees of congestion are provided in each time period, and clustering the time periods based on the degrees of congestion to obtain the plurality of clusters comprises:
generating a relationship curve of degrees of congestion with respect to time based on the degrees of congestion detected at the plurality of sampling points, for each time period; and
clustering the time periods based on a similarity among respective relationship curves to obtain the plurality of clusters.

11. The method for controlling traffic signals of claim 3, wherein a plurality of sampling points for the degrees of congestion are provided in each time period, and clustering the time periods based on the degrees of congestion to obtain the plurality of clusters comprises:
generating a relationship curve of degrees of congestion with respect to time based on the degrees of congestion detected at the plurality of sampling points, for each time period; and
clustering the time periods based on a similarity among respective relationship curves to obtain the plurality of clusters.

12. The method for controlling traffic signals of claim 4, wherein a plurality of sampling points for the degrees of congestion are provided in each time period, and clustering the time periods based on the degrees of congestion to obtain the plurality of clusters comprises:
generating a relationship curve of degrees of congestion with respect to time based on the degrees of congestion detected at the plurality of sampling points, for each time period; and
clustering the time periods based on a similarity among respective relationship curves to obtain the plurality of clusters.

13. An apparatus for controlling traffic signals, comprising:
one or more processors; and
a storage device, configured to store one or more programs,
wherein, when the one or more programs are executed by the one or more processors, the one or more processors are configured to implement a method for controlling traffic signals, comprising:
obtaining degrees of congestion detected at an intersection at respective time periods;
clustering the time periods based on the degrees of congestion to obtain a plurality of clusters;
determining target clusters from the plurality of clusters based on the degrees of congestion, wherein the degrees of congestion at the time periods included in the target clusters are greater than those at the time periods included in the rest clusters;
determining a peak period based on the time periods included in the target clusters; and
controlling the traffic signals during the peak period by using a signal control configuration corresponding to the peak period.

14. The apparatus for controlling traffic signals of claim 13, wherein the degrees of congestion are characterized by traffic and delay time of a vehicle passing through the intersection, and the one or more processors are further configured to:
determine a cluster with the longest average delay time among the clusters obtained by clustering based on the delay time, as the target cluster;
determine a cluster with the largest average traffic among the clusters obtained by clustering based on the traffic, as the target cluster; and
determine a time period that is an intersection of the time periods in the target clusters as the peak period.

15. The apparatus for controlling traffic signals of claim 14, wherein the one or more processors are further configured to:
determine a difference between a time for the vehicle to pass through the intersection that is detected at a respective time period and a set time, as the delay time,
wherein the set time is a time for the vehicle to pass through the intersection without stopping.

16. The apparatus for controlling traffic signals of claim 15, wherein the one or more processors are further configured to:
determine a time for a vehicle to pass through the intersection at night without stopping as the set time.

17. The apparatus for controlling traffic signals of claim 13, wherein the one or more processors are further configured to:
determine a number of the target clusters based on a correlation between the number of the clusters and an internal discreteness within the clusters, by using an inflection-point method,
wherein, the internal discreteness within the clusters is determined based on differences in the degrees of congestion at respective time periods in the same cluster.

18. The apparatus for controlling traffic signals of claim 13, wherein a plurality of sampling points for the degrees of congestion are provided in each time period, and the one or more processors are further configured to:
generate a relationship curve of degrees of congestion with respect to time based on the degrees of congestion detected at the plurality of sampling points, for each time period; and
cluster the time periods based on a similarity among respective relationship curves to obtain the plurality of clusters.

19. A tangible, non-transitory computer readable storage medium having a computer program stored thereon, wherein, when the program is executed by a processor, the program implements a method for controlling traffic signals, comprising:
obtaining degrees of congestion detected at an intersection at respective time periods;
clustering the time periods based on the degrees of congestion to obtain a plurality of clusters;
determining target clusters from the plurality of clusters based on the degrees of congestion, wherein the degrees of congestion at the time periods included in the target clusters are greater than those at the time periods included in the rest clusters;
determining a peak period based on the time periods included in the target clusters; and
controlling the traffic signals during the peak period by using a signal control configuration corresponding to the peak period.

20. The tangible, non-transitory computer readable storage medium of claim 19, wherein the degrees of congestion are characterized by traffic and delay time of a vehicle passing through the intersection, and determining the target clusters from the plurality of clusters based on the degrees of congestion comprises:
determining a cluster with the longest average delay time among the clusters obtained by clustering based on the delay time, as the target cluster; and
determining a cluster with the largest average traffic among the clusters obtained by clustering based on the traffic, as the target cluster, and
wherein, determining the peak period based on the time periods included in the target clusters comprises:
determining a time period that is an intersection of the time periods in the target clusters as the peak period.
